(19) United States
(12) Patent Application Publication
(10) Pub. No.: US 2024/0303515 A1
(43) Pub. Date: Sep. 12, 2024

(54) AUTOMLX COUNTERFACTUAL EXPLAINER (ACE)

(71) Applicant: Oracle International Corporation, Redwood Shores, CA (US)

(72) Inventors: Zahra Zohrevand, Vancouver (CA); Ehsan Soltan Aghai, Vancouver (CA); Yasha Pushak, Vancouver (CA); Hesam Fathi Moghadam, Sunnyvale, CA (US); Sungpack Hong, Palo Alto, CA (US); Hassan Chafi, San Mateo, CA (US)

(21) Appl. No.: 18/512,438

(22) Filed: Nov. 17, 2023

Related U.S. Application Data
(60) Provisional application No. 63/450,161, filed on Mar. 6, 2023.

(51) Int. Cl. G06N 5/04

(52) U.S. Cl. CPC G06N 5/04

(57) ABSTRACT

A computer stores a reference corpus that consists of many reference points that each has a respective class. Later, an expected class and a subject point (i.e. instance to explain) that does not have the expected class are received. Multiple reference points that have the expected class are selected as starting points. Based on the subject point and the starting points, multiple discrete interpolated points are generated that have the expected class. Based on the subject point and the discrete interpolated points, multiple continuous interpolated points are generated that have the expected class. A counterfactual explanation of why the subject point does not have the expected class is directly generated based on continuous interpolated point(s) and, thus, indirectly generated based on the discrete interpolated points. For acceleration, neither way of interpolation (i.e. counterfactual generation) is iterative. Generated interpolated points can be reused to amortize resources consumed while generating counterfactuals.

### CROSS-REFERENCE TO RELATED APPLICATION; BENEFIT CLAIM

This application claims the benefit of Provisional Application No. 63/450,161, filed Mar. 6, 2023, the entire contents of which are hereby incorporated by reference as if fully set forth herein, under 35 U.S.C. § 119(e).

### FIELD OF THE INVENTION

The present invention relates to explainable machine learning. Herein is generation of explanatory counterfactuals based on complementary interpolation phases.

### BACKGROUND

In recent years, there has been a growing interest in development of machine learning models and their interpretability. Explainable artificial intelligence (XAI) techniques aim to make machine learning models transparent and interpretable to humans in order to help users understand a machine learning model's behavior. Counterfactual explanation is one form of XAI that seeks to explain how a machine learning model's inference would have been different if some input feature(s) had been different. The main goal of a counterfactual explanation is to help users understand why a machine learning model produced a particular inference and to aid in the decision-making process related to the inference.

To be considered effective, a counterfactual explainer should fulfil the following criteria, which various existing counterfactual explainers do with mixed success.
Correctness. A counterfactual explanation should be accurate and reveal how the model's output would have changed if some input feature(s) had been different.
Diversity. The explainer should be able to generate diverse (sparse) explanations, meaning that it should provide a range of possible explanations for a model's output.
Efficiency. The explainer should be efficient and able to generate counterfactuals in a reasonable amount of time.
Feasibility. The explainer should be computationally scalable, even for very large or complex models.
Generalizability. The explainer should be able to generate explanations for a wide range of inputs and for various changes to input features, not just for specific cases or a small set of feature values.
Flexibility. The user should be able to choose the permitted range for each feature and which features to vary or fix.
Model-agnostic. The explainer should be generic to be applied to any machine learning model.

State of the art approaches may have any of the following disadvantages.
A surrogate model that did not generate the inference being explained, and the surrogate model may not always generalize well to inputs outside of the neighborhood of its training corpus.
Gradient processing that is slow and may not work well for non-differentiable models.
A decision tree that oversimplifies the full complexity of the original model.
A failure to produce counterfactuals even when they exist.
Counterfactual search on a case-by-case basis, leading to linear time complexity growth for a set of inferences to explain.
Slow training of the explainer itself.

State of the art approaches share shortcomings such as limited generalization, high computational cost, limited interpretability, limited coverage, and difficulty in handling sparse features. However, ongoing research in the field of XAI aims to address these challenges and develop new, more effective methods.

### BRIEF DESCRIPTION OF THE DRAWINGS

In the drawings:

FIG. 1 is a block diagram that depicts an example computer that generates a counterfactual explanation to reveal why a trained classifier inferred that a multidimensional subject point does not have an expected class;

FIG. 2 is a flow diagram that depicts an example computer process that generates a counterfactual explanation to reveal why a multidimensional subject point has an unexpected class;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is a machine learning explainer referred to as AutoMLx Counterfactual Explainer (ACEACE) that has speed and accuracy increased by generation of explanatory counterfactuals based on complementary interpolation phases. ACE uses a k-d tree, an efficient data structure, to find nearest neighbors of a given instance in a multidimensional feature space. Reference data is retrieved based on a set of fixed features and a desired prediction, and the retrieved data is used to prepare a valid set of counterfactuals for each instance from batch of instances to be explained.

For example, a particular motor vehicle may have an unexpected class that may be car. The expected class may be motorcycle, and a feature may be a count of wheels that is three for the particular motor vehicle. In that case, a counterfactual explanation may indicate that the particular motor vehicle would have been classified as a motorcycle as expected if the particular motor vehicle had one less wheel (which is a counterfactual). In other words, the counterfactual explanation may indicate that the particular motor vehicle has too many wheels to be a motorcycle as expected, which is why the particular motor vehicle was unexpectedly classified as a car.

The approach herein provides a user with nearest counterfactual instances with minimal feature value changes. The counterfactuals are diverse enough to cover a range of possible explanations for a model's output. To generate counterfactuals, ACE utilizes two interpolation techniques, which are discrete interpolation and continuous interpolation herein.

Counterfactuals should be as sparse as possible (i.e. minimum number of changed features). Sparse interpolation generates random discrete interpolations for each sample selected from a reference corpus as discussed later herein. Sparse interpolation probabilistically removes some of the differences between a candidate sample and the instance being explained. Sparse interpolation quickly generates sparse counterfactuals from a candidate sample.

Counterfactuals should be as near as possible to an instance being explained. Proximity interpolation generates random continuous interpolations for each candidate sample. Continuous interpolation assigns each feature a uniform random linear combination of the candidate sample and the test instance being explained. With unprecedented speed, proximity interpolation minimizes the distance between counterfactuals and the test instance.

In addition to the efficient structures, another key factor that contributes to the efficiency of ACE is batch processing. ACE tries to generate counterfactuals for the largest possible batches of the samples to be explained.

ACE has at least the following innovations. Existing counterfactual methods start with an original test data point to be explained that has an unexpected class, and then look for modifications to the test point that change the model's prediction from the unexpected class to an expected class. In many cases, this can cause these methods to fail to find any valid counterfactuals as discussed later herein. In contrast, ACE starts from all reference training points with the expected prediction, and then progressively refines the feature values to make counterfactuals that are nearer to the original test data point. A consequence is that ACE is the only counterfactual explainer that guarantees finding, in limited time, a valid counterfactual for every test instance, so long as a training example exists with given feature constraints and expected class.

In addition, unlike other solutions, this approach leverages batch processing of multiple test instances, making it at least ten times faster than state of the art counterfactual explainers. Interpolation techniques herein are non-iterative for stable time complexity. An iterative approach generates counterfactuals by iteratively modifying the input until the output changes, where the output changing is a dynamic (i.e. unpredictable) convergence criterion for ceasing iteration. The unpredictability of an iterative approach causes unstable time complexity. Avoiding iteration herein more quickly evaluates a large number of candidate counterfactuals compared to iterative approaches, thereby quickly providing a range of diverse and sparse counterfactual explanations, making ACE among the fastest explainers.

ACE offers several advantages over other methods for generating counterfactual explanations, including at least the following.
Completeness: ACE guarantees that a valid counterfactual will be found for every test instance (if a reference example exists in the training set), subject to the given feature constraints. This is an important property for ensuring that a user will be provided with some results and the generated counterfactuals are useful for explaining model predictions.
Diversity and Sparsity: ACE uses interpolation techniques to provide a range of diverse and sparse counterfactual explanations and has quality (i.e. accuracy) competitive to the best counterfactual explainers. This helps users understand how small changes to the input features can affect the model's output, and also enables them to explore different possible explanations for a model's predictions.
Efficiency: ACE is designed to be fast, with an average runtime of less than one second per test instance. It achieves this speed by using batch processing and k-d tree structures to quickly find valid counterfactuals for many test instances.
Compatibility (Model-agnostic): ACE can be used with a variety of machine learning models, including opaque (i.e. black-box) models.
Flexibility: another key feature of ACE is its flexibility for customization of a permitted range for each feature and the ability to choose which features are fixed or varied.

Batching herein provides unprecedented acceleration that is scalable such that a bigger batch achieves increased acceleration due to reuse of generated counterfactuals for multiple test instances in a batch. The bigger is a batch, the more opportunities there are for reusing counterfactuals, which means greater amortization of the time cost and the space cost of generating a counterfactual. In this way, batching saves processor time and processor electricity and decreases memory demand per generated explanation. This is in stark contrast to the state of the art that does not batch and thus cannot amortize consumption of computer resources across multiple explanations for different respective test points.

Compared to the state of the art, ACE needs less running time per instance to explain, succeeds at generating a valid solution more often, and generates counterfactuals that, despite having a different class from the instance to explain, are nearer (i.e. more similar) to the instance to explain within a multidimensional feature space as discussed later herein. This increased proximity of counterfactuals to the instance to explain increases the accuracy of the generated explanation. In other words, ACE is more accurate than the state of the art.

When assessing proximity of a counterfactual to an explained instance, it does not matter how distance is measured. ACE generates counterfactuals that are empirically nearer according to spatial distance metrics such as maximum mean discrepancy (MMD), L2 Euclidian, and L1 Manhattan. ACE generates counterfactuals that are empirically nearer according to a non-spatial distance metric such as L0 zero norm (i.e. sparsity), which can also be used for categorical (i.e. non-numeric) features.

In an embodiment, a computer stores a reference corpus that consists of many reference points that each has a respective class. Later, an expected class and a subject point (i.e. instance to explain) that does not have the expected class are received. Multiple reference points that have the expected class are selected as starting points. Based on the subject point and the starting points, multiple discrete interpolated points are generated that have the expected class. Based on the subject point and the discrete interpolated points, multiple continuous interpolated points are generated that have the expected class. A counterfactual explanation of why the subject point does not have the expected class is directly generated based on continuous interpolated points and, thus, indirectly generated based on the discrete interpolated points. For acceleration, neither way of interpolation (i.e. counterfactual generation) is iterative. With batching for additional acceleration, these generated interpolated points can be reused to amortize resources consumed while generating counterfactuals.

### 1.0 Example Computer

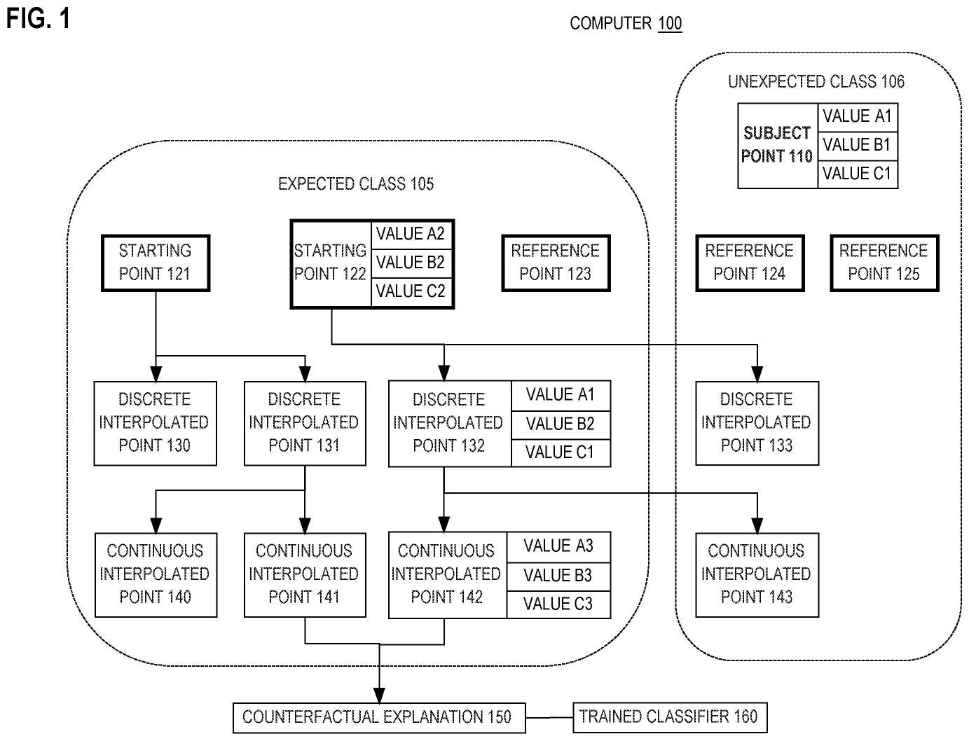

FIG. 1 is a block diagram that depicts an example computer 100. Computer 100 may be one or more of a rack server such as a blade, a personal computer, a mainframe, or a virtual computer.

All components shown in FIG. 1 may be loaded, generated, or operated in random access memory (RAM) of computer 100 that generates counterfactual explanation 150 to reveal why trained classifier 160 inferred that multidimensional subject point 110 does not have expected class 105. A point may be a data structure that represents an object such as a photograph, a document, a log entry, or a record such as a row in a spreadsheet or in a database table. Many points may occur in a multidimensional feature space that is defined by features A-C (not shown) that each provides a respective dimension to the feature space. Each point has a respective value for each of features A-C. For example, subject point 110 has values A1-C1 respectively for features A-C. Herein, a subject point may also be referred to as a test point or an instance to explain.

### 1.1 Counterfactual Explanation

Subject point 110 has unexpected class 106 that may, for example, be car; expected class 105 may be motorcycle; and feature A may be a count of wheels that is three for subject point 110. In that case, counterfactual explanation 150 may indicate that subject point 110 would have been classified as a motorcycle as expected if subject point 110 had one less wheel (which is a counterfactual). In other words, counterfactual explanation 150 may indicate that subject point 110 has too many wheels to be a motorcycle, which is why subject point 110 was unexpectedly classified as a car.

Generation of counterfactual explanation 150 entails generating explanatory counterfactuals shown as interpolated points 130-133 and 140-143, and this generation occurs in complementary interpolation phases described herein. Herein, an interpolated point is a synthetic (i.e. generated) point that does not occur in a preexisting reference corpus that contains reference points 121-125 that are shown with a thick outline to indicate that reference points 121-125 are predefined. Starting points 121-122 are a specially selected set of reference points as discussed below. Reference points 121-125 were generated by trained classifier 160, although possibly on a different computer and possibly before computer 100 existed. Reference points 121-125 each was classified as having exactly one of multiple mutually-exclusive classes 105-106 that may include additional classes not shown. For example, reference points 121-123 have expected class 105 as already inferred by trained classifier 160 that may or may not be an opaque (i.e. black box) machine learning model.

Subject point 110 and its inferred classification by trained classifier 160 may be archival or live. Subject point 110 has bold text to indicate that subject point 110 is a point of interest for which counterfactual explanation 150 is being generated according to the shown sequence of operational phases T1-T4. Each phase generates and/or selects points based on explanatory relevance that increases throughout the sequence of phases as follows. Phase T1 finds a relevant portion of the reference corpus from which phases T2-T3 synthesize better points by interpolation as discussed later herein.

### 1.2 Selection of Multiple Starting Points

State of the art generation of counterfactuals is not robust and, in some scenarios, may fail to generate a usable counterfactual or may waste time generating many more unusable than usable ones. For example if a counterfactual is sought having expected class 105, the state of the art may sometimes generate many unusable counterfactuals of unexpected class 106 (or other classes) but none or almost none of expected class 105.

Phase T1 overcomes those problems in two ways. A first way is that phase T1 selects a reference point as a starting point that has expected class 105. As discussed later herein, interpolation phase T2 will use a starting point as a prototype from which to generate counterfactuals that are likely to have expected class 105.

A second way is that phase T1 selects multiple reference points as multiple starting points 121-122 that have expected class 105. As discussed later herein, interpolation phase T2 using all starting points 121-122 increases diversity of counterfactuals that will be generated. For example if starting point 121 is at or near a classification boundary in the multidimensional feature space, then many or most counterfactuals that will be generated from starting point 121 might have unexpected class 106.

Diversity of starting points increases the likelihood that at least one starting point will not be near a classification boundary. For example if two classes 105-106 are demonstratively considered as two clusters in the multidimensional feature space, then a classification boundary is a region (not shown) where both clusters are adjacent to each other.

An embodiment may have a predefined limit that is a count of how many starting points to select in expected class 105. In this example, the limit is two, which is why reference point 123 is not selected as a starting point even though reference point 123 has expected class 105. In an embodiment, the limit is k, and only k nearest neighbors of subject point 110 in expected class 105 are selected as starting points. For example, a k-NN algorithm may be used to select starting points 121-122.

### 1.3 Reference K-D Tree

An embodiment that does not use a k-NN algorithm may, instead, use a k-d tree (not shown) for acceleration. However, the k of a k-d tree is not the k of k-NN. The k of a k-d tree instead is a count of dimensions (i.e. features). A k-d tree is a binary tree that partitions a space of k features, which logically clusters multidimensional points according to values of the points' features.

In an embodiment not shown, phase T1 selects only starting points that have the same values as subject point 110 for some feature(s) but not all of features A-C. In that embodiment, phase T1 might select only starting points in expected class 105 that have same value C1 as subject point 110 for feature C. In that case, feature C is referred to herein as a fixed feature. Regardless of how many features are or are not fixed, k features for a k-d tree is all of features A-C.

Although not shown, various embodiments may have multiple subject points either in sequence or in a batch as discussed later herein. Each of multiple subject points has its own respective class and its own respective expected class. For example, subject point 110 has class 106, but class 105 is the expected class. Another subject point (not shown) may have the opposite. For example, another subject point may have class 105, but class 106 is the expected class.

A k-d tree generated by phase T1 is referred to herein as a reference k-d tree. In a batched embodiment, phase T1 generates a distinct reference k-d tree per batch. In a non-batched embodiment, phase T1 may generate a distinct reference k-d tree per subject point, which is logically or operationally equivalent to a batch size of one (i.e. one subject point), which lacks acceleration by counterfactual reuse as discussed later herein.

### 1.4 Batch Contains Multiple Instances to be Explained

The expected class is the same for all subject points in a same batch (not shown). All subject points in a same batch have a same respective value for each fixed feature (if any). Even if the (i.e. unexpected) class is different for two subject points, they can be put into a same batch.

Even if the expected class is the same for two subject points, they will be put into distinct respective batches if their values of fixed feature(s) are different. For acceleration multiple batches may be concurrently processed, regardless of which phases T1-T4 are involved. Besides concurrency, batching provides additional acceleration discussed later herein.

A batch's reference k-d tree is populated only with reference points that match all fixed features (if any) and the expected class of the batch. Instead of using a k-NN algorithm, nearest neighbors may be obtained in an accelerated way by querying a k-d tree. After populating a reference k-d tree, phase T1 may use subject point 110 as a lookup key to query the reference k-d tree to select starting points 121-122 that are nearest neighbors of subject point 110 in expected class 105. Each batch has its own reference k-d tree, and each batch has its own starting points.

Even though a batch has only one reference k-d tree, each of multiple subject points in the batch has its own respective multiple starting points. For example, starting point 122 may be a starting point for zero or more other subject points (not shown) in the same batch as subject point 110 or other batches of same expected class 105. Likewise, reference point 123 is not a starting point for subject point 110 but may be a starting point for zero or more other subject points in a same or different batch.

Herein, discussion of subject point 110, its starting points, and its generated counterfactuals is demonstrative and intended to describe operation of each individual subject point in a same batch as subject point 110. For example, all subject points in the batch are used as lookup keys to individually query the batch's one reference k-d tree, and all subject points in the batch are individually used to generate multiple respective counterfactuals as follows.

Proximity of counterfactuals in the multidimensional feature space to subject point 110 increases the relevance of counterfactuals that will be generated. Relevant counterfactuals increases the accuracy of counterfactual explanation 150.

### 1.5 Counterfactual Generation by Interpolation

Generation of counterfactuals occurs in each of interpolation phases T2-T3. Phase T2 generates discrete interpolated points 130-133 as imperfect copies of starting points 121-122. For example, multiple discrete interpolated points 132-133 are generated as imperfect copies of starting point 122.

Herein, an interpolated point is a point that is generated only to generate an explanation (e.g. 150). Subject point 110 and reference points 121-125 are not interpolated points because they are not generated to generate counterfactual explanation 150. Herein, an interpolated point is one kind of counterfactual, and all counterfactuals in this approach are interpolated points. An interpolated point is different from other kinds of counterfactuals because the interpolated point is generated based on two other points.

In particular, an interpreted point is a hybrid of two other points. However as discussed later herein, how hybridization of the two other points occurs depends on which kind of interpolated point is being generated, which depends on which of phases T2-T3 is generating the interpolated point. Likewise, selection of the two other points depends on which of phases T2-T3 is generating the interpolated point. Herein and regardless of which kind of interpolated point is being generated by which of phases T2-T3, one of the two other points always is a subject point (e.g. 110) and one of the two other points is not a subject point.

### 1.6 Discrete Interpolation

Herein, a discrete interpolated point is an imperfect copy of a starting point in which zero or more features are permuted based on subject point 110. A feature is permuted by obtaining its value from subject point 110 instead of from a starting point. In the shown example, features A and C are permuted by copying values A1 and C1 from subject point 110 into discrete interpolated point 132. Values for unpermuted features are instead copied from a respective starting point. For example as shown, points 122 and 132 have same value B2 for unpermuted feature B.

Even though discrete interpolated points 132-133 are imperfect copies of same starting point 122, which features are permuted may be different between discrete interpolated points 132-133. For example, feature A is permuted in discrete interpolated point 132, but feature A may or may not be permuted in discrete interpolated point 133.

In an embodiment, discrete interpolated points 132-133 may have different counts of permuted features. For example, two features A and C are permuted in discrete interpolated point 132, but discrete interpolated point 133 might only have zero or one permuted features. In an embodiment, each feature has a same predefined probability (e.g. 25% chance) of being permuted in a discrete interpolated point. If the predefined probability is approximately half (i.e. 50%) such as a predefined probability between forty and sixty percent, in which case the predefined probability behaves like a fair or mostly fair coin toss.

If a discrete interpolated point has no permuted features, it is a perfect copy of its starting point. If all features A-C are permuted in a discrete interpolated point, it is a perfect copy of subject point 110, which has explanatory power only for other subject points in the batch or, without batching, can be discarded. In most cases, a discrete interpolated point has a mix of permuted and unpermuted features, in which case the discrete interpolated point is a hybrid of both of its starting point and subject point 110.

Multiple discrete interpolated points are generated from multiple subject points in a same batch. In phase T2, trained classifier 160 individually classifies (i.e. infers a respective class) all discrete interpolated points generated for the batch. For example, any point may be encoded as a feature vector that is, for example, an array of real numbers. In other words, any feature of any datatype may be encoded as one or more numbers. Herein, all features A-C may be processed in numeric form, regardless of original datatype.

Herein, a point and its feature vector are treated as synonymous. Trained classifier 160 accepts one point (i.e. feature vector) as input, which causes trained classifier 160 to classify the point by inferring the point's class. In that way, computer 100 detects the respective classes of all interpolated points generated in each of phases T2-T3.

Permutation by phase T2 may cause some discrete interpolated point(s) to cross a classification boundary as discussed earlier herein. For example as shown, discrete interpolated point 133 has class 106 even though its starting point 122 has expected class 105. In that case, discrete interpolated point 133 is discarded. A batch has only one expected class, and all interpolated points having a different class are discarded, regardless of whether generated by interpolation phase T2 or T3.

The sole purpose herein for operation of trained classifier 160 by computer 100 is to detect which interpolated points to discard, more or less immediately after generating those interpolated points. In other words, computer 100 uses trained classifier 160 solely as a filter, even though trained classifier 160's original (or future) purpose and application may be different. Only interpolated points having the same class as the expected class of the batch are retained for further processing discussed later herein.

Likewise, discrete interpolated point 130 is discarded if it does not have all of the batch's values for fixed features. In that case and for acceleration, discrete interpolated point 130 can be discarded without using trained classifier 160 to classify discrete interpolated point 130.

### 1.7 Sparsity K-D Tree

Interpolation phase T2 retains discrete interpolated points 130-132 that have needed expected class 105 in a sparsity k-d tree that phase T2 generates, and this is not the reference k-d tree that phase T1 generated. A batch generates, populates, and queries only one reference k-d tree, one sparsity k-d tree and, as discussed later herein, one proximity k-d tree. Multiple batches do not share a k-d tree. Each of phases T2-T4 respectively queries the batch's reference k-d tree, sparsity k-d tree, or proximity k-d tree. Each of phases T2-T4 uses each subject point in the batch as a lookup key to query the batch's respective k-d tree as discussed later herein.

Sparsity herein is as follows. Permutation does not generate a new value for a feature, because permutation instead copies feature values that already exist in the reference corpus. Herein, such a preexisting feature value may be referred to as a discrete value, and discrete interpolation may be referred to as permuted interpolation or sparse interpolation.

Herein, permutation is only one way of interpolation. Herein, interpolation generates (i.e. synthesizes) a counterfactual (i.e. interpolated point) from two points. That is, interpolation combines two points to generate an interpolated point.

Phase T2 uses discrete interpolation based on permutation. Permutation is also referred to herein as sparse interpolation because usually only some (i.e. not all, e.g. few) features are permuted, where many or most feature values are directly copied from a starting point when generating an interpolated point as an imperfect copy of the starting point.

### 1.8 Continuous Interpolation

Phase T3 uses continuous interpolation, instead of discrete interpolation, to generate an interpolated point from two points as follows. Herein, continuous interpolation entails generating a continuous interpolated point that, for demonstration, resides anywhere within an imaginary multidimensional bounding box (not shown), which is a convex subspace within the multidimensional feature space, that is defined by a discrete interpolated point and subject point 110. The diagonal of the multidimensional bounding box is a Euclidean line segment whose end points are the discrete interpolated point and subject point 110. Herein, continuous interpolation may also be referred to as convex interpolation or, as discussed below, diversity interpolation.

Continuous interpolation occurs separately for each non-fixed feature of a continuous interpolated point being generated and entails randomly generating a value for, for example, feature B within a range whose limits are both values of that feature in, for example, discrete interpolated point 132 and subject point 110. Demonstratively, this is random selection of a value along an imaginary line segment whose endpoints are values B1-B2. For example, continuous interpolated points 142-143 both are linear interpolations between points 110 and 132. Value B3 for feature B of continuous interpolated point 142 is randomly generated between values B1-B2 of respective points 110 and 132.

In an embodiment, random generation of an interpolated feature value has a uniform distribution instead of a normal distribution. Regardless of probability distribution, continuous interpolated points 140-141 are nearer to subject point 110 than is discrete interpolated point 131 from which continuous interpolated points 140-141 were generated. Thus, continuous interpolation may be referred to herein as proximity interpolation.

Interpolation phase T3 operates as follows. Subject point 110 is used as a lookup key to query the sparsity k-d tree to select discrete interpolated points 131-132 that are k nearest neighbors of subject point 110. For example if k is two, then discrete interpolated point 130 is not selected as one of the nearest neighbors of subject point 110, although discrete interpolated point 130 may be selected for zero or more other subject points in the batch.

In various examples, a batch contains two subject points X-Y (not shown), and discrete interpolated point Z is generated from subject point X. Because subject points X-Y are in the same batch and share a same sparsity k-d tree that contains discrete interpolated point Z, phase T3 may select discrete interpolated point Z as one of the nearest neighbors of: only subject point X, only subject point Y, both subject points X-Y, or neither of subject points X-Y.

### 1.9 Proximity K-D Tree

When discrete interpolated point 132 is selected from the sparsity k-d tree for subject point 110, phase T3 generates multiple continuous interpolated points 142-143 by random convex interpolation between points 110 and 132 as discussed above. As shown, continuous interpolated point 143 has unexpected class 106 and is discarded. For the batch, phase T3 generates only one proximity k-d tree and populates it with all continuous interpolated points that have same class 105 that is the expected class of the batch.

Likewise, continuous interpolated point 140 is discarded if it does not have all of the batch's values for fixed features. In that case and for acceleration, continuous interpolated point 140 can be discarded without using trained classifier 160 to classify continuous interpolated point 140.

Phase T4 generates a respective explanation for each subject point in the batch. Counterfactual explanation 150 is generated based on subject point 110 and the proximity k-d tree of the batch as follows. Subject point 110 is used as a lookup key to query the proximity k-d tree to select continuous interpolated points 141-142 that are k nearest neighbors of subject point 110. For example if k is two, then continuous interpolated point 140 is not selected as one of the nearest neighbors of subject point 110, although continuous interpolated point 140 may be selected for zero or more other subject points in the batch.

### 1.10 Reusing Counterfactuals to Generate Multiple Explanations for a Batch

In various examples, a batch contains both subject points X-Y, and continuous interpolated point W is generated from subject point X. Because subject points X-Y are in the same batch and share a same proximity k-d tree that contains continuous interpolated point W, phase T4 may select continuous interpolated point W as one of the nearest neighbors of: only subject point X, only subject point Y, both subject points X-Y, or neither of subject points X-Y. One respective counterfactual explanation is generated for each of subject points X-Y, and continuous interpolated point W may be used to generate zero, one, or both of those explanations.

In an extreme example, an explanation of a particular subject point is generated based on: a) only starting point(s) selected for a different subject point in the same batch, b) only discrete interpolated point(s) based on those starting point(s) and not based on the particular subject point, and c) only continuous interpolated point(s) based on those discrete interpolated point(s) and not based on the particular subject point. In other words for a same batch, there is no limit on multiple subject points sharing of intermediate (i.e. starting or interpolated) points.

Thus, sharing (i.e. reusing) intermediate points to generate respective explanations for multiple subject points may be incorporated into processing of a batch by design. In that case, fewer interpolated points need to be generated because some reuse of interpolated points is presumed by design. For example without sharing, phase T2 may generate thirty discrete interpolated points per selected starting point, and phase T3 may generate thirty continuous interpolated points per selected discrete interpolated point. Instead with sharing and without loss of quality/accuracy, phase T2 may generate only twenty discrete interpolated points per selected starting point, and phase T3 may generate only twenty continuous interpolated points per selected discrete interpolated point.

Generating fewer interpolated points and sharing some of them means that phases T2-T3 are accelerated and use less memory without loss of quality. Thus, batching provides acceleration by sharing interpolated points, in addition to acceleration by concurrent processing of multiple batches.

### 1.11 Avoidance of Failure

In another extreme example, a batch has an expected class, and the batch contains many subject points, but the reference corpus contains only one reference point having that expected class. In that case, all of those subject points share that reference point as their sole starting point. Despite having only one starting point for the batch, phase T2 generates, for each subject point, multiple discrete interpolated points from that starting point and, from each discrete interpolated point, multiple continuous interpolated points. Thus, even with only one starting point for an entire batch, the relevant regions of the multidimensional feature space still are explored and accurate explanations for those subject points still are generated. This is an improvement over the state of the art that does not guarantee to find or generate points needed to generate an explanation. For example, when the expected class is rare in the reference corpus, the state of the art may sometimes fail to generate an explanation.

Compared to the state of the art, computer 100 has an empirically lower failure rate for any reference corpus. For a reference corpus that contains at least one reference point for every class, computer 100 never fails to generate an explanation, unlike the state of the art. In those ways, computer 100 has increased reliability over the state of the art.

### 1.12 Example Counterfactual Explanation

Based on continuous interpolated points 141-142, counterfactual explanation 150 is generated exclusively for subject point 110. Counterfactual explanation 150 may contain, reference, or identify expected class 105 and/or class 106 of subject point 110, one or more of points 110 and 141-142, and one or more of their features or feature values. Counterfactual explanation 150 may or may not be presented (e.g. displayed) in tabular form or as natural language prose. In an embodiment, counterfactual explanation 150 is visualized by spatially showing one or more of points 110 and 141-142 with or without showing classification boundary(s).

After phase T4 finishes processing the batch, all of the batch's k-d trees are discarded, and some or all of the batch's interpolated points are discarded. For example, continuous interpolated points 141-142 may or may not be retained after phase T4 such as for ongoing support of counterfactual explanation 150 if needed by the implementation.

### 2.0 Example Counterfactual Explanation Process

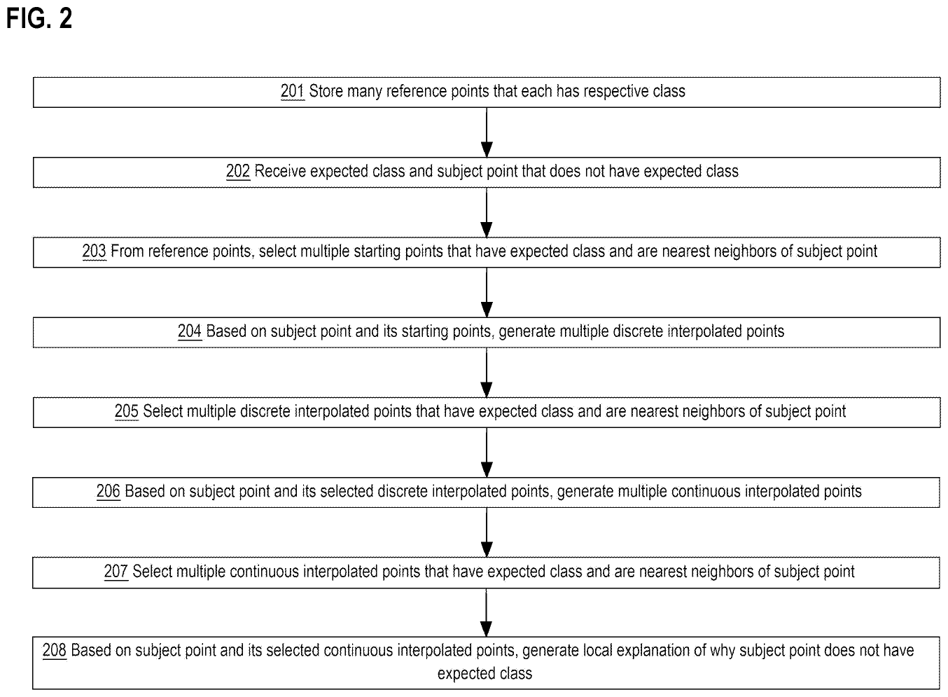

FIG. 2 is a flow diagram that depicts an example process that computer 100 may perform to generate counterfactual explanation 150 to reveal why trained classifier 160 inferred that multidimensional subject point 110 has unexpected class 106.

In random access memory (RAM) of computer 100, step 201 stores a reference corpus that contains many reference points 121-125 that each has a respective class of classes 105-106. For example, it is already known that reference point 125 has class 106. In other words, the reference corpus, which may contain tens or tens of thousands of reference points, already was labeled. The reference corpus may or may not be all or a portion of a training corpus that was used to train trained classifier 160 on some computer (e.g. 100).

Step 202 receives expected class 105 (e.g. by identifier and without any points in the class) and subject point 110 that has unexpected class 106. For example into RAM of computer 100, step 202 may load tens or thousands of subject points and separate them into multiple batches, where each batch has a distinct combination of expected class and values of fixed features as discussed earlier herein. In some examples, there are no fixed features, in which case there is one batch per distinct expected class. If a count of subject points in a huge batch would exceed a predefined limit, the huge batch is implemented as multiple limit-sized batches that have a same combination of expected class and values of fixed features. However, the bigger is a batch, the more acceleration by sharing counterfactuals will occur, which may be a reason not to limit batch size.

For each batch, step 202 generates a respective distinct reference k-d tree and populates it only with the reference points in the reference corpus that have the same combination of class and values of fixed features as the batch. Use of a reference k-d tree, a sparsity k-d tree, or a proximity k-d tree, as discussed earlier herein, is exemplary and provides acceleration. Other embodiments may lack k-d trees and may instead use other techniques or data structures to index, organize, filter, or select points.

Remaining steps 203-208 are repeated for each batch (e.g. concurrently). For example, multiple batches may be concurrently processed by a same or different step. For example, a small batch may race ahead through several steps and finish before a big batch.

Remaining steps 203-208 also are repeated for each subject point in a batch, even though the batch has or will have only one reference k-d tree, one sparsity k-d tree, and one proximity k-d tree, and these three k-d trees are shared by all subject points in the batch. For example, each of steps 203-208 may contain a respective control flow loop that processes each distinct subject point in a respective distinct iteration. That is, one iteration in one step processes one subject point, which may entail generating and/or processing multiple intermediate (i.e. starting or interpolated) points.

For demonstration, the following discussion presumes that subject point 110 is the one subject point of a current iteration of a step. However, a current iteration is demonstrative. For example, multiple iterations in a same step may concurrently occur in some embodiments.

From the reference k-d tree of the batch, step 203 selects multiple starting points 121-122 that have expected class 105 and are k nearest neighbors of subject point 110 as discussed earlier herein. Any time during or after step 202 but before step 204, only one sparsity k-d tree is generated for the batch.

Based on subject point 110 and its starting points 121-122, step 204 generates multiple discrete interpolated points 130-133 as discussed earlier herein. Into the batch's sparsity k-d tree, step 204 stores all discrete interpolated points generated for the batch by step 204, except those discrete interpolated points that do not have the batch's expected class 105 or do not have all of the batch's values of fixed features. As discussed earlier herein, step 204 uses trained classifier 160 to detect which discrete interpolated points do not have expected class 105 and discards them.

From the sparsity k-d tree of the batch, step 205 selects multiple discrete interpolated points 131-132 that have expected class 105 and are k nearest neighbors of subject point 110 as discussed earlier herein. Any time during or after step 202 but before step 206, only one proximity k-d tree is generated for the batch.

Based on subject point 110 and selected discrete interpolated points 131-132, step 206 generates multiple continuous interpolated points 140-143 as discussed earlier herein. Into the batch's proximity k-d tree, step 206 stores all continuous interpolated points generated for the batch by step 206, except those continuous interpolated points that do not have the batch's expected class 105 or do not have all of the batch's values of fixed features. As discussed earlier herein, step 206 uses trained classifier 160 to detect which continuous interpolated points do not have expected class 105 and discards them.

From the proximity k-d tree of the batch, step 207 selects multiple continuous interpolated points 141-142 that have expected class 105 and are k nearest neighbors of subject point 110 as discussed earlier herein.

Based on subject point 110 and its selected continuous interpolated points 141-142, step 208 generates counterfactual explanation 150 of why subject point 110 does not have class 105 as discussed earlier herein. Step 208 may display, archive, or email any or all of the multiple explanations that step 208 generated for the batch.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

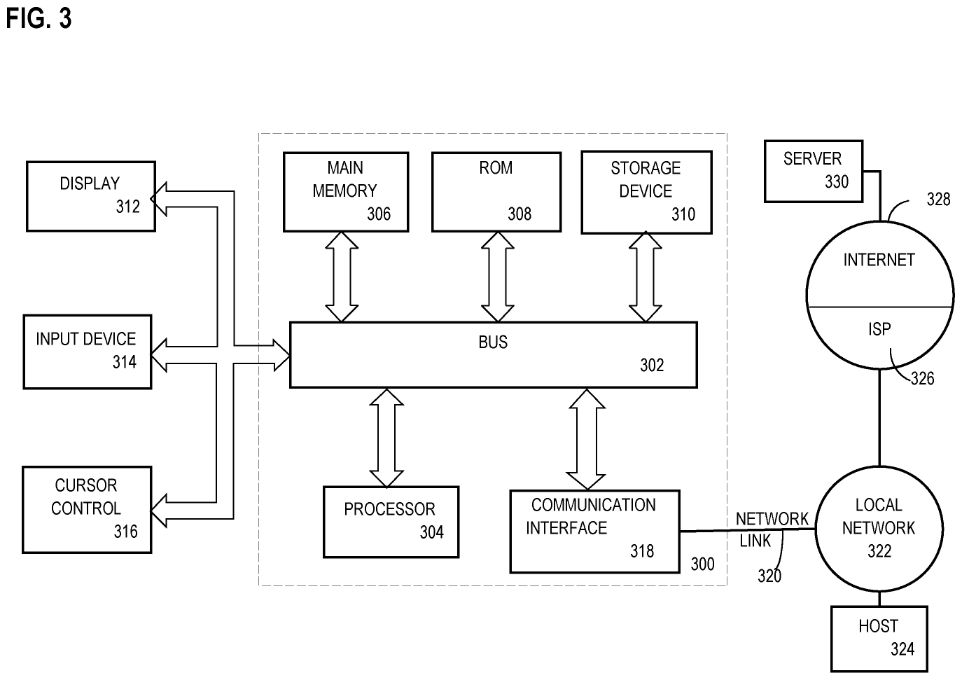

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interACE 318 coupled to bus 302. Communication interACE 318 provides a two-way data communication coupling to a network link 320 that is connected to a local network 322. For example, communication interACE 318 may be an integrated services digital network (ISDN) card, cable modem, satellite modem, or a modem to provide a data communication connection to a corresponding type of telephone line. As another example, communication interACE 318 may be a local area network (LAN) card to provide a data communication connection to a compatible LAN. Wireless links may also be implemented. In any such implementation, communication interACE 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interACE 318, which carry the digital data to and from computer system 300, are example forms of transmission media.

Computer system 300 can send messages and receive data, including program code, through the network(s), network link 320 and communication interACE 318. In the Internet example, a server 330 might transmit a requested code for an application program through Internet 328, ISP 326, local network 322 and communication interACE 318.

The received code may be executed by processor 304 as it is received, and/or stored in storage device 310, or other non-volatile storage for later execution.

### Software Overview

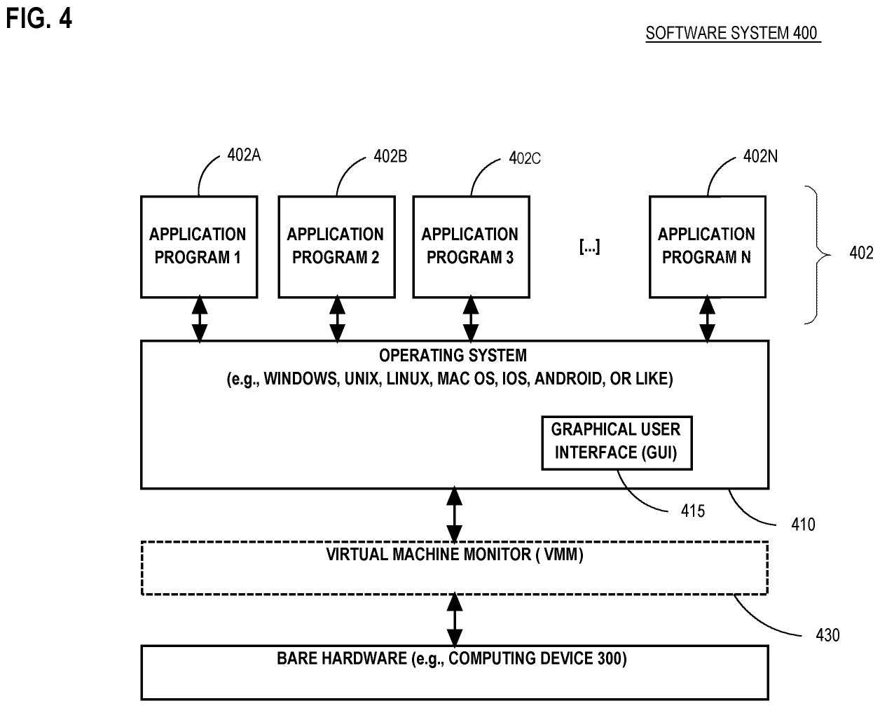

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interACE (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a plurality of reference points that each has a respective class;
receiving, after said storing the plurality of reference points, an expected class and a subject point that does not have the expected class;
selecting, from the plurality of reference points, a plurality of starting points that have the expected class;
generating, based on the subject point and the plurality of starting points that have the expected class, a plurality of discrete interpolated points that have the expected class; and
generating, based on the plurality of discrete interpolated points that have the expected class, a counterfactual explanation of why the subject point does not have the expected class;
wherein the method is performed by one or more computers.

2. The method of claim 1 wherein said generating the plurality of discrete interpolated points that have the expected class comprises respectively interpolating between the subject point and each starting point of the plurality of starting points.

3. The method of claim 2 wherein said interpolating between the subject point and a particular starting point of the plurality of starting points comprises assigning a value of the subject point to a copy of the particular starting point.

4. The method of claim 3 wherein said assigning the value of the subject point to the copy of the particular starting point occurs at a probability between forty and sixty percent.

5. The method of claim 1 wherein said generating the counterfactual explanation of why the subject point does not have the expected class comprises generating a plurality of continuous points by respectively interpolating between the subject point and multiple discrete interpolated points.

6. The method of claim 5 wherein said interpolating between the subject point and a particular discrete interpolated point of the plurality of discrete interpolated points comprises interpolating between a value of the subject point and a value of the particular discrete interpolated point.

7. The method of claim 6 wherein said interpolating between the value of the subject point and the value of the particular discrete interpolated point comprises randomly generating a convex combination of the value of the subject point and the value of the particular discrete interpolated point.

8. The method of claim 7 wherein said randomly generating the convex combination of the value of the subject point and the value of the particular discrete interpolated point comprises using a uniform probability distribution.

9. The method of claim 5 further comprising selecting multiple nearest neighbors of the subject point from a plurality of points that contains at least one selected from a group consisting of:
a subset of the plurality of reference points that have the expected class,
said plurality of discrete interpolated points, and
said plurality of continuous interpolated points.

10. The method of claim 9 further comprising storing, in a k-d tree, at least one selected from a group consisting of:
a subset of the plurality of reference points that have the expected class,
said plurality of discrete interpolated points, and
said plurality of continuous interpolated points.

11. The method of claim 1 further comprising generating a respective at least one k-d tree for each batch in a plurality of batches that contain subject points.

12. The method of claim 1 wherein:
the subject point is a first subject point;
the method further comprises after said storing the plurality of reference points:
storing the first subject point and a second subject point that does not have the expected class in a batch that has at least one k-d tree;
querying, with the first subject point, each k-d tree of said at least one k-d tree of the batch; and
querying, with the second subject point, each k-d tree of said at least one k-d tree of the batch.

13. One or more non-transitory computer-readable media storing instructions that, when executed by one or more processors, cause:
storing a plurality of reference points that each has a respective class;
receiving, after said storing the plurality of reference points, an expected class and a subject point that does not have the expected class;
selecting, from the plurality of reference points, a plurality of starting points that have the expected class;
generating, based on the subject point and the plurality of starting points that have the expected class, a plurality of discrete interpolated points that have the expected class; and
generating, based on the plurality of discrete interpolated points that have the expected class, a counterfactual explanation of why the subject point does not have the expected class.

14. The one or more non-transitory computer-readable media of claim 13 wherein said generating the plurality of discrete interpolated points that have the expected class comprises respectively interpolating between the subject point and each starting point of the plurality of starting points.

15. The one or more non-transitory computer-readable media of claim 14 wherein said interpolating between the subject point and a particular starting point of the plurality of starting points comprises assigning a value of the subject point to a copy of the particular starting point.

16. The one or more non-transitory computer-readable media of claim 13 wherein said generating the counterfactual explanation of why the subject point does not have the expected class comprises generating a plurality of continuous points by respectively interpolating between the subject point and multiple discrete interpolated points.

17. The one or more non-transitory computer-readable media of claim 16 wherein said interpolating between the subject point and a particular discrete interpolated point of the plurality of discrete interpolated points comprises interpolating between a value of the subject point and a value of the particular discrete interpolated point.

18. The one or more non-transitory computer-readable media of claim 16 wherein the instructions further cause selecting multiple nearest neighbors of the subject point from a plurality of points that contains at least one selected from a group consisting of:
a subset of the plurality of reference points that have the expected class,
said plurality of discrete interpolated points, and
said plurality of continuous interpolated points.

19. The one or more non-transitory computer-readable media of claim 13 wherein the instructions further cause generating a respective at least one k-d tree for each batch in a plurality of batches that contain subject points.

20. The one or more non-transitory computer-readable media of claim 13 wherein:
the subject point is a first subject point;
the instructions further cause after said storing the plurality of reference points:
storing the first subject point and a second subject point that does not have the expected class in a batch that has at least one k-d tree;
querying, with the first subject point, each k-d tree of said at least one k-d tree of the batch; and
querying, with the second subject point, each k-d tree of said at least one k-d tree of the batch.
